(19) United States
(12) Patent Application Publication
(10) Pub. No.: US 2006/0024552 A1
(43) Pub. Date: Feb. 2, 2006

(54) Fuel cell system

(75) Inventors: Goro Fujita, Ota-shi (JP); Hiroki Kabumoto, Saitama-shi (JP); Takeshi Minamiura, Ora-gun (JP)

Correspondence Address: MCDERMOTT WILL & EMERY LLP, 600 13TH STREET, N.W., WASHINGTON, DC, 20005-3096, US

(73) Assignee: SANYO ELECTRIC CO., LTD.

(21) Appl. No.: 11/191,972

(22) Filed: Jul. 29, 2005

(30) Foreign Application Priority Data
Jul. 29, 2004 (JP) 2004-221556

(51) Int. Cl. H01M 8/04

(52) U.S. Cl. 429/34

(57) ABSTRACT

In a fuel cell system which dilutes a liquid fuel to supply the diluted liquid fuel to an anode, it is intended to achieve stable electricity generation capacity. The fuel cell system generates electricity by an electrochemical reaction between the liquid fuel and an oxidant, and this system comprises a cell which generates electricity by the electrochemical reaction; a fuel container containing the liquid fuel of high concentration; and a buffer tank which dilutes the liquid fuel in the fuel container to supply the diluted liquid fuel to the anode of the cell, wherein an electromagnetic valve is provided in a fuel supply path between the fuel container and the buffer tank to prevent the liquid fuel from flowing back from the buffer tank to the fuel container.

### TECHNICAL FIELD

The present invention relates to a fuel cell system in which a liquid fuel is supplied to a cell to generate electricity.

### BACKGROUND ART

In recent years, there has been an increase in development of fuel cell which generate electricity by an electrochemical reaction between a fuel and an oxidant, in view of environmental problems and energy saving. This fuel cell is a device which generates electric energy from the fuel and the oxidant and can provide high electricity generation efficiency. Further, the fuel cell is mainly characterized in that electricity is directly generated without undergoing any process associated with heat energy and kinetic energy unlike a conventional electricity generation scheme and the high electricity generation efficiency can therefore be expected even on a small scale, and in that it is environmentally advantageous because nitrogen compounds and the like are discharged in a small amount and because noise and vibration are less.

Such a fuel cell can efficiently utilize chemical energy available in the fuel and have environmentally friendly characteristics, so that it is expected to be an energy supply system playing an active role in the 21st century, and regarded as a promising new electricity generation system available for various purposes such as use in space, automobiles, portable equipment, ranging from large-scale electricity generation to small-scale electricity generation, and hence full-scale technological development have been started for a practical application.

In particular, attention has been recently focused on a direct methanol fuel cell (DMFC) as one form of the fuel cell. In the DMFC, methanol which is a liquid fuel is directly supplied, without being reformed, to an anode of a cell where it electrochemically reacts with oxygen, thereby providing electric power. Since methanol generates higher energy than hydrogen per unit volume and is suited to storage with low risk of, for example, explosion, it is expected to be used for power supplies of the automobiles, portable equipment, etc (e.g., refer to Japanese Patent Publication Laid-open No. 2002-373684).

On the other hand, in such a DMFC, a problem is caused when methanol of high concentration is directly supplied to the anode that methanol passes through a polymer electrolytic membrane to reach a cathode side and decreases a potential of a cathode, and therefore, dilution means called a buffer tank is generally used to dilute methanol with water to about 3% before supplying it to the anode. In this case, the buffer tank is in communication, via a fuel supply path, with a fuel container containing methanol of high concentration, and methanol of high concentration is supplied from the fuel container by a pump provided in a fuel cell supply path. In the meantime, water generated in the cathode is collected in the buffer tank and is used to dilute methanol of high concentration, but a concentration of a methanol solution generated by dilution in the buffer tank is controlled by turning on/off the pump.

However, in the path on a fuel cell side including the inside of the buffer tank, pressure is high because the cathode is supplied with air which is the oxidant. Therefore, if the pump is stopped, the methanol solution produced by dilution in the buffer tank will flow back to the fuel supply path. As a result of such backflow of the methanol solution to the fuel supply path, the diluted methanol solution comes back to the buffer tank even if the pump is operated next time, which causes a problem that the concentration rapidly decreases to degrade electricity generation capacity.

Such a problem also occurs when air bubbles are mixed in the fuel supply path. However, when the fuel container is produced as a detachable cartridge to facilitate handling, it is inevitable that the air bubbles enter the fuel supply path, for example, when the fuel container is replaced.

The present invention has been attained to solve the foregoing conventional technical problems, and is intended to stabilize the electricity generation capacity in a fuel cell system in which the liquid fuel is diluted and then supplied to the anode.

### SUMMARY OF THE INVENTION

A fuel cell system according to a first invention of the present application generates electricity by an electrochemical reaction between a liquid fuel and an oxidant, and the fuel cell system comprises a cell which generates electricity by the electrochemical reaction; a fuel container containing the liquid fuel of high concentration; and a buffer tank which dilutes the liquid fuel in the fuel container to supply the diluted liquid fuel to an anode of the cell, wherein backflow prevention means is provided in a fuel supply path between the fuel container and the buffer tank to prevent the liquid fuel from flowing back from the buffer tank to the fuel container.

According to the fuel cell system in a second invention of the present application, in the above, the backflow prevention means is provided in the vicinity of the buffer tank in the fuel supply path.

According to the fuel cell system in a third invention of the present application, in the above inventions, the fuel cell system comprises a pump to supply the buffer tank with the liquid fuel in the fuel container, and the backflow prevention means comprises a valve device which opens/closes synchronously with an operation/stopping of the pump.

According to the fuel cell system in a fourth invention of the present application, in the first and second inventions, the backflow prevention means comprises a check valve which allows the liquid fuel to pass from the fuel container to the buffer tank and which deters the liquid fuel from passing from the buffer tank to the fuel container.

A fuel cell system according to a fifth invention of the present application generates electricity by an electrochemical reaction between a liquid fuel and an oxidant, and the fuel cell system comprises a cell which generates electricity by the electrochemical reaction; a buffer tank which dilutes the liquid fuel of high concentration to supply the diluted liquid fuel to an anode of the cell; a fuel supply path which supplies the liquid fuel of high concentration to the buffer tank; a fuel container containing the liquid fuel of high concentration and detachably connected to the fuel supply path; and an air bubble collecting means for collecting air bubbles in the fuel supply path.

According to the fuel cell system in a sixth invention of the present application, in the above, the air bubble collecting means comprises a pump provided in the fuel supply path to supply the buffer tank with the liquid fuel in the fuel container, a fuel sub-tank and flow path switching means; and an entrance of the fuel sub-tank is brought into communication with the fuel supply path by the flow path switching means and the pump is operated in order to collect, into the fuel sub-tank, the air bubbles in the fuel supply path, while an exit of the fuel sub-tank is brought into communication with the fuel supply path by the flow path switching means and the pump is operated in order to supply the buffer tank with the liquid fuel in the fuel sub-tank.

According to the fuel cell system in a seventh invention of the present application, in the above, the pump is operated while the fuel container is brought into communication, via the fuel supply path, with the buffer tank by the flow path switching means in order to supply the liquid fuel from the fuel container to the buffer tank; and when the pump is stopped, the flow path switching means deters the liquid fuel from flowing from the buffer tank to the fuel supply path.

A fuel cell system according to an eighth invention of the present application generates electricity by an electrochemical reaction between a liquid fuel and an oxidant, and the fuel cell system comprises a cell which generates electricity by the electrochemical reaction; a buffer tank which dilutes the liquid fuel of high concentration to supply the diluted liquid fuel to an anode of the cell; a fuel supply path which supplies the liquid fuel of high concentration to the buffer tank; and a fuel container containing the liquid fuel of high concentration and detachably connected to the fuel supply path, wherein the fuel container comprises an exterior case, and a fuel bag housed in the exterior case and filled with the liquid fuel; and the fuel bag has a plurality of compartments in communication with each other and is housed in the exterior case in a folded state.

The fuel cell system according to the first invention of the present application generates electricity by the electrochemical reaction between the liquid fuel and the oxidant, and the fuel cell system comprises the cell which generates electricity by the electrochemical reaction; the fuel container containing the liquid fuel of high concentration; and the buffer tank which dilutes the liquid fuel in the fuel container to supply the diluted liquid fuel to the anode of the cell, wherein backflow prevention means is provided in the fuel supply path between the fuel container and the buffer tank to prevent the liquid fuel from flowing back from the buffer tank to the fuel container, so that it is possible to prevent a disadvantage that when the liquid fuel is supplied from the fuel container to the buffer tank, the diluted liquid fuel flown back from the buffer tank to the fuel supply path comes back to the buffer tank to decrease the concentration of the liquid fuel. Thus, the liquid fuel of proper concentration can be stably supplied to the cell, and stable electricity generation capacity can be achieved.

Furthermore, as in the aforementioned second invention, the backflow prevention means is provided in the vicinity of the buffer tank in the fuel supply path, so that it is possible to minimize the diluted liquid fuel diffused from the buffer tank to flow back to the fuel supply path, and various functional components can be added to the fuel supply path between the backflow prevention means and the fuel container.

Furthermore, as in the third invention, the fuel cell system comprises the pump to supply the buffer tank with the liquid fuel in the fuel container, and the backflow prevention means comprises the valve device which opens/closes synchronously with the operation/stopping of the pump, so that it is possible to ensure the prevention of backflow of the diluted liquid fuel from the buffer tank while the liquid fuel of high concentration is smoothly supplied from the fuel container to the buffer tank.

Furthermore, as in the fourth invention, the backflow prevention means comprises the check valve which allows the liquid fuel to pass from the fuel container to the buffer tank and which deters the liquid fuel from passing from the buffer tank to the fuel container, so that it is possible to prevent the backflow of the diluted liquid fuel from the buffer tank with a simple configuration.

The fuel cell system according to the fifth invention of the present application generates electricity by the electrochemical reaction between the liquid fuel and the oxidant, and the fuel cell system comprises the cell which generates electricity by the electrochemical reaction; the buffer tank which dilutes the liquid fuel of high concentration to supply the diluted liquid fuel to the anode of the cell; the fuel supply path which supplies the liquid fuel of high concentration to the buffer tank; the fuel container containing the liquid fuel of high concentration and detachably connected to the fuel supply path; and the air bubble collecting means for collecting the air bubbles in the fuel supply path, thereby making it possible to smoothly collect the air bubbles mixed in the fuel supply path, for example, when the fuel container is detached. Thus, such a disadvantage is prevented that electricity cannot be generated due to air flowing into the anode of the cell, and the stable electricity generation capacity can be achieved.

Furthermore, as in the sixth invention, the air bubble collecting means comprises the pump provided in the fuel supply path to supply the buffer tank with the liquid fuel in the fuel container, the fuel sub-tank and the flow path switching means; the entrance of the fuel sub-tank is brought into communication with the fuel supply path by the flow path switching means and the pump is operated in order to collect, into the fuel sub-tank, the air bubbles in the fuel supply path, so that the air bubbles mixed in the fuel supply path can be absolutely and rapidly collected into the fuel sub-tank together with the liquid fuel.

In addition, the exit of the fuel sub-tank is brought into communication with the fuel supply path by the flow path switching means and the pump is operated in order to supply the buffer tank with the liquid fuel in the fuel sub-tank, so that while the fuel container is detached for replacement, the liquid fuel collected in the fuel sub-tank can be supplied to the buffer tank to continue the electricity generation.

Furthermore, as in the seventh invention, the pump is operated while the fuel container is brought into communication, via the fuel supply path, with the buffer tank by the flow path switching means in order to supply the liquid fuel from the fuel container to the buffer tank, and when the pump is stopped, the flow path switching means deters the liquid fuel from flowing from the buffer tank to the fuel supply path, so that the backflow of the diluted liquid fuel from the buffer tank to the fuel supply path can be prevented while the liquid fuel of high concentration is smoothly supplied from the fuel container to the buffer tank.

The fuel cell system according to the eighth invention of the present application generates electricity by the electrochemical reaction between the liquid fuel and the oxidant, and the fuel cell system comprises the cell which generates electricity by the electrochemical reaction; the buffer tank which dilutes the liquid fuel of high concentration to supply the diluted liquid fuel to the anode of the cell; the fuel supply path which supplies the liquid fuel of high concentration to the buffer tank; and the fuel container containing the liquid fuel of high concentration and detachably connected to the fuel supply path, wherein the fuel container comprises the exterior case, and the fuel bag housed in the exterior case and filled with the liquid fuel, and the fuel bag has a plurality of compartments in communication with each other and is housed in the exterior case in a folded state, so that the liquid fuel of high concentration can be drawn from the fuel bag without turning over the fuel bag regardless of a direction of the fuel container and that an invalid space produced in the exterior case can be minimized to improve volumetric efficiency.

### BRIEF DESCRIPTION OF THE DRAWINGS

FIG. 1 is a front perspective view of a fuel cell system in an embodiment to which the present invention is applied;

FIG. 2 is a rear perspective view of the fuel cell system of FIG. 1;

FIG. 3 is a configuration diagram of the fuel cell system of FIG. 1 (Embodiment 1);

FIG. 4 is a configuration diagram extracting components around a fuel supply pipe in FIG. 3 (Embodiment 1);

FIG. 5 is a perspective view of a fuel container of the fuel cell system of FIG. 1;

FIG. 6 is a perspective view of a fuel bag of the fuel container of FIG. 5;

FIG. 7 is a diagram showing a configuration of the fuel bag of FIG. 6;

FIG. 8 is a diagram to explain the fuel bag of FIG. 6 in a folded state;

FIG. 9 is a configuration diagram extracting the components around the fuel supply pipe of the fuel cell system in another embodiment of the present invention (Embodiment 2);

FIG. 10 is a control flowchart of a microcomputer on a control substrate in the embodiment of FIG. 9;

FIG. 11 is also a control flowchart of the microcomputer on the control substrate in the embodiment of FIG. 9;

FIG. 12 is also a control flowchart of the microcomputer on the control substrate in the embodiment of FIG. 9;

FIG. 13 is also a control flowchart of the microcomputer on the control substrate in the embodiment of FIG. 9;

FIG. 14 is also a control flowchart of the microcomputer on the control substrate in the embodiment of FIG. 9;

FIG. 15 is also a control flowchart of the microcomputer on the control substrate in the embodiment of FIG. 9;

FIG. 16 is also a control flowchart of the microcomputer on the control substrate in the embodiment of FIG. 9;

FIG. 17 is also a control flowchart of the microcomputer on the control substrate in the embodiment of FIG. 9;

FIG. 18 is also a control flowchart of the microcomputer on the control substrate in the embodiment of FIG. 9;

FIG. 19 is also a control flowchart of the microcomputer on the control substrate in the embodiment of FIG. 9;

FIG. 20 is a diagram to explain operations of a fuel pump and a three-way valve in the embodiment of FIG. 9;

FIG. 21 is also a diagram to explain the operations of the fuel pump and the three-way valve in the embodiment of FIG. 9;

FIG. 22 is also a diagram to explain the operations of the fuel pump and the three-way valve in the embodiment of FIG. 9;

FIG. 23 is also a diagram to explain the operations of the fuel pump and the three-way valve in the embodiment of FIG. 9; and

FIG. 24 is also a diagram to explain the operations of the fuel pump and the three-way valve in the embodiment of FIG. 9.

### DETAILED DESCRIPTION OF THE EMBODIMENTS

Embodiments of the present invention will hereinafter be described in detail with reference to the drawings.

### Embodiment 1

A fuel cell system 1 in this embodiment uses methanol as a liquid fuel, and it is a so-called direct methanol fuel cell (DMFC) system which generates electricity by an electrochemical reaction between methanol and air as an oxidant in a cell, and is designed to have compact overall dimensions so that it can be used as a power supply for, for example, a portable notebook-size computer.

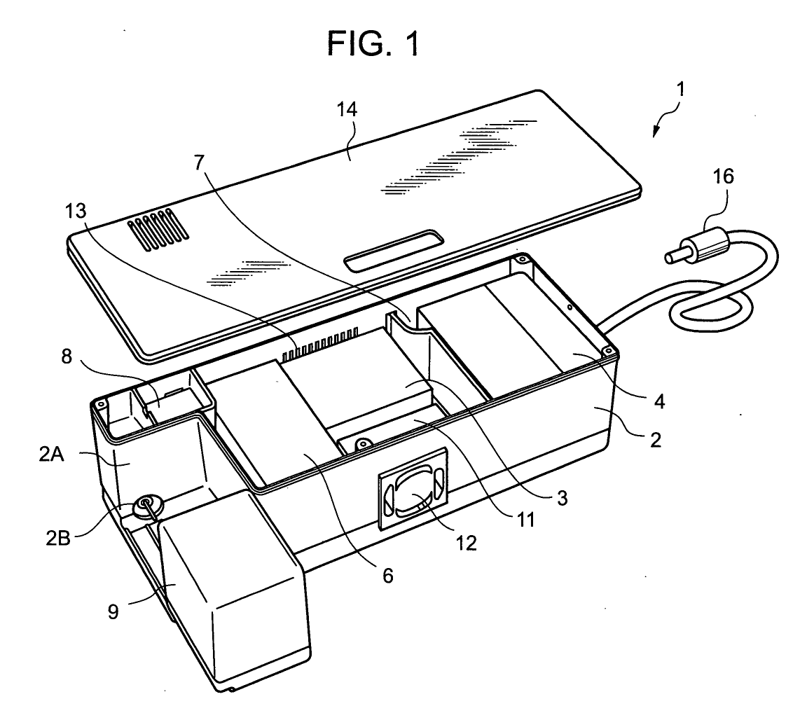

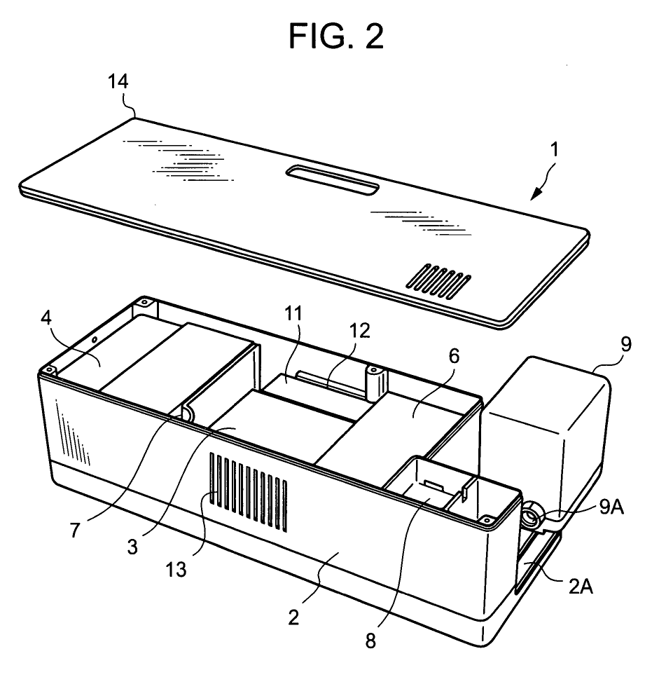

That is, in the fuel cell system 1, a fuel cell (stack) 3 is installed substantially in the center of a case 2 as shown in FIG. 1 and FIG. 2, and a control unit 4 is provided on one side of a longitudinal direction of the case 2 while an auxiliary unit 6 is provided on the other side thereof. Further, an auxiliary power (secondary battery) 7 is provided between the control unit 4 and the fuel cell 3, and a gas-liquid separator 8, a fuel container 9 and the like are installed on a side of the auxiliary unit 6 opposite to the fuel cell 3. It is to be noted that the auxiliary power 7 is provided to supply electric power and absorb a load change when the fuel cell 3 is activated. The fuel container 9 contains methanol of high concentration as the liquid fuel. Moreover, a heat exchanger 11 is provided between the control unit 4 and the auxiliary unit 6 adjacently to the fuel cell 3, and the case 2 is fitted with a cooling fan 12 to blow air to the heat exchanger 11 and the fuel cell 3. 13 denotes exhaust holes formed in a wall surface of the case 2 on a side opposite to the cooling fan 12.

An upper side of the case 2 is closed by a removable lid 14, and a power output connector 16 connected to the control unit 4 extends from the case 2. Further, the fuel container 9 is a cartridge type to be detachably provided in a fuel container attachment portion 2A concavely formed in the case 2 on the gas-liquid separator 8 side. Moreover, a joint 2B is formed in the fuel container attachment portion 2A, and a joint 9A on the fuel container 9 side is detachably connected to this joint 2B.

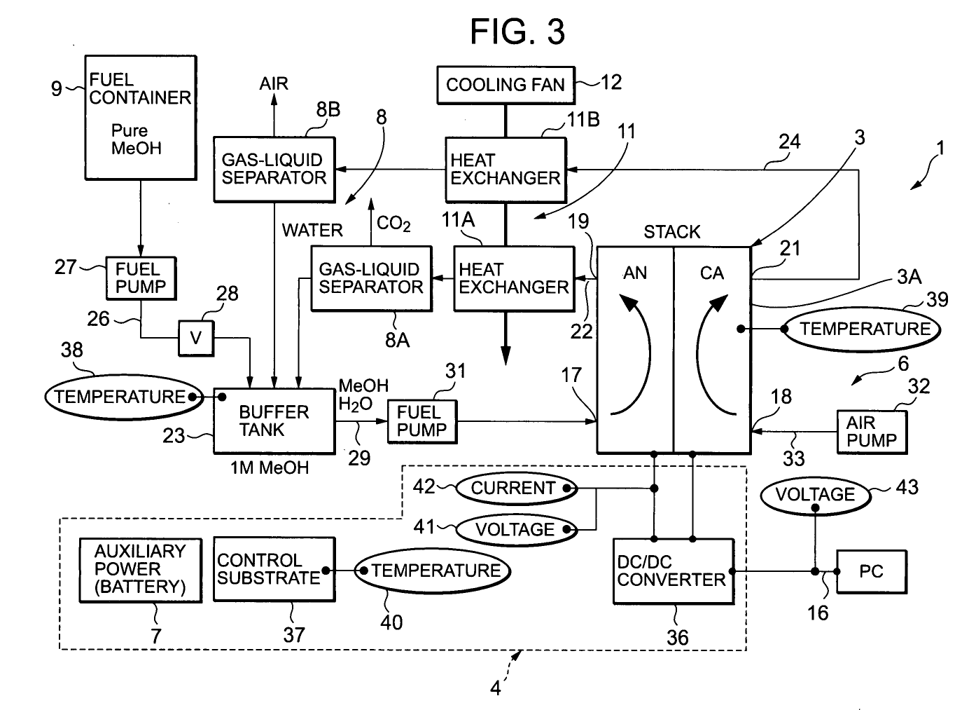

Next, in FIG. 3, a plurality of cells 3A is stacked in which an unshown membrane electrode assembly (MEA) is held by separators in a sandwiched state, thereby constituting the fuel cell 3. At terminals of this fuel cell 3, there are provided a fuel supply port 17, an oxidant supply port 18, a fuel discharge port 19 and an oxidant discharge port 21. Within the fuel cell 3, there are provided a fuel supply manifold, an oxidant supply manifold, a fuel discharge manifold and an oxidant discharge manifold which are not shown and which penetrate the fuel cell 3 in a direction in which the cells 3A are stacked. In this configuration, a liquid fuel and the oxidant are respectively supplied from the fuel supply port 17 and the oxidant supply port 18 to each of the cells 3A via the fuel supply manifold and the oxidant supply manifold, while a waste fuel, a waste oxidant, produced water and the like from each of the cells 3A are respectively discharged from the fuel discharge manifold and the oxidant discharge manifold via the fuel discharge port 19 and the oxidant discharge port 21.

Since the fuel cell 3 in the embodiment employs a direct methanol fuel cell (DMFC) which uses methanol as the liquid fuel and air as the oxidant, waste methanol (a methanol solution), waste carbon dioxide and the like are discharged from the fuel discharge port 19, while waste air, the produced water and the like are discharged from the oxidant discharge port 21. Waste methanol, waste carbon dioxide and the like discharged from the fuel discharge port 19 are introduced into a buffer tank 23 through a fuel discharge pipe 22. Further, the waste air, the produced water and the like discharged from the oxidant discharge port 21 are introduced into the buffer tank 23 through an oxidant discharge pipe 24.

In this case, a heat exchanger 11A constituting a part of the above-mentioned heat exchanger 11 and a gas-liquid separator 8A constituting a part of the above-mentioned gas-liquid separator 8 are provided to intervene in the fuel discharge pipe 22, and waste methanol passing through the fuel discharge pipe 22 is cooled down and liquefied by the cooling fan 12 in the heat exchanger 11A, and then a gas is separated from a liquid in the gas-liquid separator 8A, whereby waste carbon dioxide is only discharged outside and waste methanol is only introduced into the buffer tank 23.

Furthermore, a heat exchanger 11B constituting a part of the above-mentioned heat exchanger 11 and a gas-liquid separator 8B constituting a part of the above-mentioned gas-liquid separator 8 are also provided to intervene in the oxidant discharge pipe 24, and in this configuration, the produced water passing through the oxidant discharge pipe 24 is cooled down and liquefied by the cooling fan 12 in the heat exchanger 11B, and then the gas is separated from the liquid in the gas-liquid separator 8B, whereby the waste air is only discharged outside and the waste water is only introduced into the buffer tank 23.

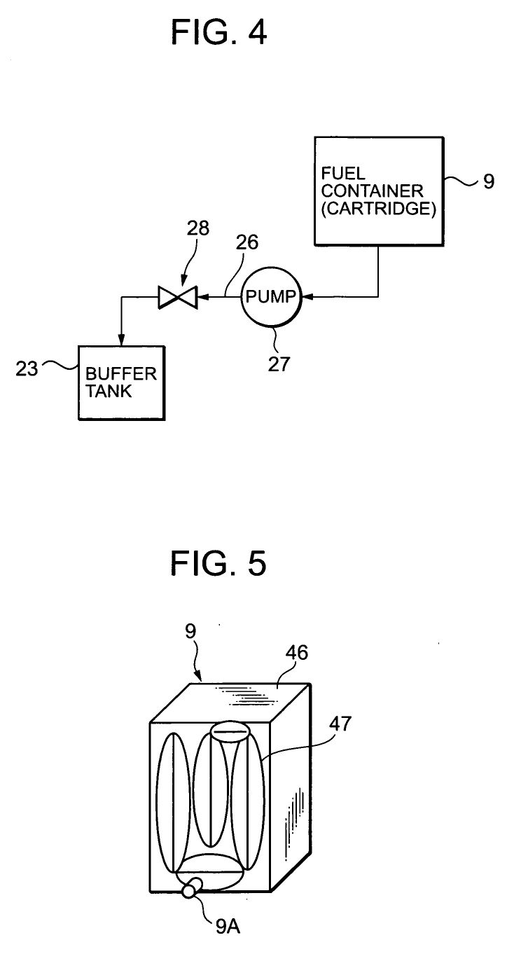

The buffer tank 23 is provided under the above-mentioned gas-liquid separator 8 in the case 2, and functions as means for diluting methanol (liquid fuel) of high concentration introduced from the fuel container 9 as described later. That is, one end of a fuel supply pipe 26 constituting a fuel supply path of the present invention is connected to the buffer tank 23, while the other end of the fuel supply pipe 26 is connected to the above-mentioned joint 2B. Further, a fuel pump 27 and an electromagnetic valve 28 as backflow prevention means are provided to intervene in the fuel supply pipe 26 as additionally shown in FIG. 4, and in particular, the electromagnetic valve 28 is placed in the vicinity of the buffer tank 23 on a discharge side of the fuel pump 27 (in the vicinity of the one end of the fuel supply pipe 26). Moreover, the fuel pump 27 and the electromagnetic valve 28 are arranged in the case 2 in the vicinity of the joint 2B and the buffer tank 23.

The fuel container 9 communicates with the fuel supply pipe 26 in a state where the joint 9A of the fuel container 9 is detachably connected to the joint 2B of the case 2. When the electromagnetic valve 28 is opened, the buffer tank 23 is in communication with the fuel container 9 via the fuel supply pipe 26 and the fuel pump 27. When the fuel pump 27 is operated in this state, methanol of high concentration in the fuel container 9 is supplied to the buffer tank 23 via the fuel supply pipe 26 and the electromagnetic valve 28.

Methanol of high concentration supplied to the buffer tank 23 is diluted with the produced water introduced from the oxidant discharge pipe 24, and is adjusted to a concentration of, for example, about 3% (or 0.5 mol/L to 2 mol/L) in the embodiment. A diluted fuel supply pipe 29 is connected between an exit of the buffer tank 23 and the fuel supply port 17 of the fuel cell 3, and a fuel circulation pump 31 included in the auxiliary unit 6 is provided to intervene in this diluted fuel supply pipe 29.

Furthermore, when the fuel circulation pump 31 is operated, the diluted methanol solution (liquid fuel) in the buffer tank 23 is supplied from the fuel supply port 17 to an anode of each cells 3A of the fuel cell 3 through the diluted fuel supply pipe 29. On the other hand, the air (oxidant) blown from an air pump 32 included in the auxiliary unit 6 is supplied from the oxidant supply port 18 to a cathode of each of the cells 3A through an oxidant supply pipe 33.

In each of the cells 3A, methanol in the methanol solution supplied to the anode thereof electrochemically reacts with oxygen in the air supplied to the cathode thereof, thereby generating electricity. A reaction on the anode side under these circumstances is indicated by Formula (1), a reaction on the cathode side is indicated by Formula (2), and an overall reaction is indicated by Formula (3).
CH₃OH+H₂O→CO₂+6H⁺+6e⁻ (1)
O₂+4H⁺+4e→2H₂O (2)
CH₃OH+ 3/2O₂→CO₂+2H₂O (3)

Electric power thus generated in the fuel cell 3 is adjusted to a predetermined voltage in a DC/DC converter 36 included in the control unit 4, and then supplied to, for example, a notebook-size computer PC (or its battery (secondary battery)) via the above-mentioned connector 16. It is to be noted that 37 denotes a control substrate included in the control unit 4 which comprises a general purpose microcomputer. Further, 38 to 40 denote temperature sensors to detect temperatures of the buffer tank 23, the fuel cell 3 and the control substrate 37, 41, 42 denote a voltage sensor and a current sensor to detect an output voltage and an output current of the fuel cell 3, and 43 denotes a voltage sensor to detect an output voltage of the DC/DC converter 36. Outputs of these sensors are input to the control substrate 37, and in accordance with these outputs, the control substrate 37 controls drive components such as the fuel pump 27, the fuel circulation pump 31, the electromagnetic valve 28, the air pump 32 and the cooling fan 12.

In this case, when the output of the fuel cell 3 is below a specified value, the control substrate 37, in accordance with the outputs from the voltage sensor 41 and the current sensor 42, opens (ON) the electromagnetic valve 28 for a predetermined period, and operates (ON) the fuel pump 27 to supply the buffer tank 23 with methanol of high concentration in the fuel container 9. After the predetermined period has passed, the fuel pump 27 is stopped (OFF) and the electromagnetic valve 28 is closed (OFF), thereby stopping the supply of methanol of high concentration to the buffer tank 23. Thus, the fuel cell pump 27 and the electromagnetic valve 28 are intermittently turned on and off so that the concentration of the methanol solution in the buffer tank 23 is adjusted to the above-mentioned value to maintain the electricity generation in the fuel cell 3.

Here, pressure is applied into the buffer tank 23 from the air pump 32 or the like via the oxidant discharge pipe 24 or the like, so that if the fuel pump 27 stops in the absence of the electromagnetic valve 28, the methanol solution diluted in the buffer tank 23 will flow back from an entrance of the buffer tank 23 to the fuel supply pipe 26. When the diluted methanol solution flows back to the fuel supply pipe 26, the diluted methanol solution comes back to the buffer tank 23 even if the fuel pump 27 is operated to supply methanol of high concentration, which causes a problem that the concentration of the methanol solution in the buffer tank 23 rapidly decreases to stop the electric generation of the fuel cell 3.

However, in the present invention, the electromagnetic valve 28 is provided in the fuel supply pipe 26, and the control substrate 37 opens (ON) or closes (OFF) the electromagnetic valve 28 synchronously with the operation (ON) or stopping (OFF) of the fuel pump 27 as described above, and therefore, a flow path of the fuel supply pipe 26 can be closed while the fuel pump 27 is stopped. Thus, it is possible to prevent a disadvantage that the methanol solution flows back from the buffer tank 23 to the fuel supply pipe 26 while the fuel pump 27 is stopped, so that the methanol solution of proper concentration can be stably supplied to the anodes of the cells 3A, and electricity generation capacity of the fuel cell 3 can be stabilized.

In particular, because the electromagnetic valve 28 is provided in the vicinity of the buffer tank 23 of the fuel supply pipe 26, it is possible to minimize the methanol solution diffused from the buffer tank 23 to flow back to the fuel supply pipe 26. Further, components such as a sub-tank described later can be added to the fuel supply pipe 26 between the electromagnetic valve 28 and the fuel container 9.

In particular, if the electromagnetic valve 28 is provided which opens (ON) or closes (OFF) synchronously with the operation (ON) or stopping (OFF) of the fuel pump 27 as in the embodiment, it is possible to ensure the prevention of backflow of the methanol solution from the buffer tank 23 while methanol of high concentration is smoothly supplied from the fuel container 9 to the buffer tank 23.

It is to be noted that the electromagnetic valve 28 is provided to prevent the backflow in the embodiment described above, but this is not a limitation and a check valve may be provided in the fuel supply pipe 26 in the vicinity of the buffer tank 23. In this case, the check valve is placed in such a direction as to allow methanol to pass from the fuel container 9 to the buffer tank 23 while deterring the methanol solution from passing from the buffer tank 23 to the fuel container 9. Thus, the backflow of the methanol solution from the buffer tank 23 can be prevented by a simple configuration as compared to the above-mentioned case where the electromagnetic valve 28 is provided.

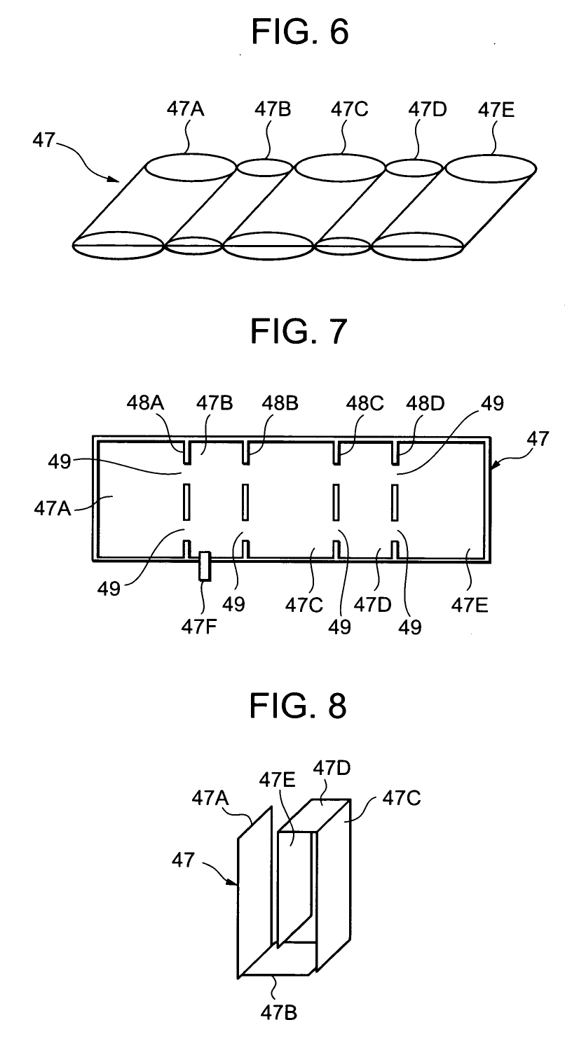

Here, FIG. 5 is a transmitting perspective view of the fuel container 9. The fuel container 9 comprises an substantially rectangular exterior case 46 and a fuel bag 47 (FIG. 6) housed in the exterior case 46, and the joint 9A is formed at a lower end portion of the exterior case 46. The fuel bag 47 is configured by stacking, for example, two flexible sheets having a methanol resistance property and by welding a periphery thereof, and is filled with methanol of high concentration. Further, the fuel bag 47 is divided into five compartments 47A to 47E by four welded portions 48A to 48D as shown in FIG. 7, and the compartments 47A to 47E are internally in communication with each other through communicating portions 49, 49. Moreover, the compartment 47B is provided with an exit 47F in the embodiment.

Furthermore, such a fuel bag 47 is spirally folded by use of the welded portions 48A to 48D as shown in FIG. 8, and is housed in this state into the exterior case 46. Moreover, the exit 47F is connected to the above-mentioned joint 9A. In this way, the fuel bag 47 is internally divided into the plurality of compartments 47A to 47E and housed in the exterior case 46 in a folded state, so that methanol of high concentration can be drawn from the fuel bag 47 by the above-mentioned fuel pump 27 without turning over the fuel bag 47 regardless of a direction of the fuel container 9 (a direction of the fuel cell system 1 itself). Moreover, as the fuel bag 47 is housed in the fuel bag 46 with no space between them, an invalid space produced in the exterior case 46 can be minimized to improve volumetric efficiency.

### Embodiment 2

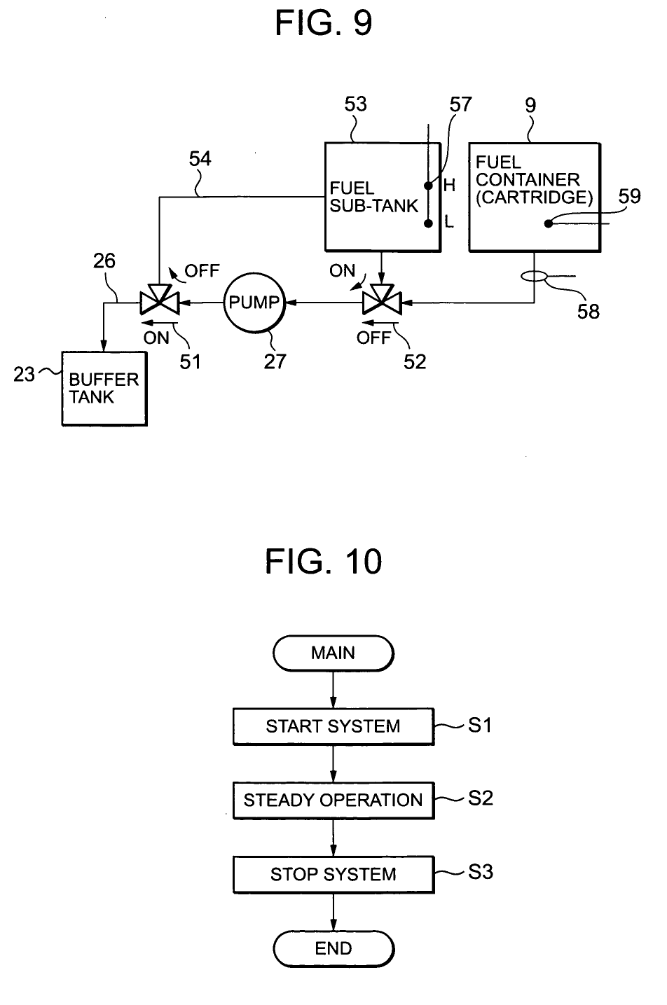

Next, FIG. 9 shows a configuration around a fuel supply pipe 26 of a fuel cell system 1 in another embodiment of the present invention. It is to be noted that FIG. 9 shows, in an extracting manner, a configuration ranging from a fuel container 9 to a buffer tank 23 of the fuel cell system 1 in this case, while other parts are the same as those in FIG. 3. In this case, instead of the electromagnetic valve 28 in FIG. 4, a three-way valve 51 (electromagnetic valve 1) and a three-way valve 52 (electromagnetic valve 2) as flow path switching means are connected to the fuel supply pipe 26 on an outlet side and an inlet side of a fuel pump 27. One end of an air bubble collecting pipe 54 is further connected to the three-way valve 51 and is in communication with an upper portion of the fuel supply pipe 26, while the other end of the air bubble collecting pipe 54 is connected to an entrance formed in an upper portion of an open-to-air type fuel sub-tank 53. This fuel sub-tank 53 is open to the air at a proper location in an upper end portion thereof. Further, an exit formed at a lower end of the fuel sub-tank 53 is connected to the three-way valve 52 via a fuel outflow pipe 56. The fuel sub-tank 53, the three-way valves 51, 52 and the fuel pump 27 constitute air bubble collecting means of the present invention in this case.

The three-way valve 51 is provided in the fuel supply pipe 26 in the vicinity of the buffer tank 23, and when this three-way valve 51 is conducted (ON), a flow path of the fuel supply pipe 26 between the fuel pump 27 and the buffer tank 23 is opened and the fuel supply pipe 26 is separated from the air bubble collecting pipe 54. That is, the entrance of the fuel sub-tank 53 is brought out of communication with the fuel supply pipe 26. When the three-way valve 51 is not conducted (OFF), it brings an outlet side of the fuel pump 27 of the fuel supply pipe 26 into communication with the air bubble collecting pipe 54, and separates the buffer tank 23 side from the fuel pump 27 and the air bubble collecting pipe 54. That is, an entrance of the buffer tank 23 is brought out of communication with the fuel pump 27 side of the fuel supply pipe 26.

The three-way valve 52 in a nonconducting state (OFF) opens the flow path of the fuel supply pipe 26 between the fuel container 9 and the fuel pump 27, and separates the fuel outflow pipe 56 from the fuel supply pipe 26. That is, the exit of the fuel sub-tank 53 is not brought into communication with the fuel supply pipe 26. When the three-way valve 52 is conducted (ON), it brings the inlet side of the fuel pump 27 of the fuel supply pipe 26 into communication with the fuel outflow pipe 56 and separates the fuel container 9 side from the fuel pump 27 side. That is, the fuel container 9 is brought out of communication with the fuel pump 27 side of the fuel supply pipe 26.

Furthermore, the three-way valves 51, 52 are also controlled by the above-mentioned control substrate 37. In this case, a level sensor 57 is provided in the fuel sub-tank 53 to detect an amount of methanol therein, and a level sensor 58 is also provided in the fuel supply pipe 26 (made of a transparent pipe) in the vicinity of a joint 2B to optically detect whether the fuel has run out. Moreover, a fuel container switch (or sensor) 59 is provided in a fuel container attachment portion 2A of a case 2 to detect whether the fuel container 9 is detached, and both outputs of these sensors are input to the control substrate 37.

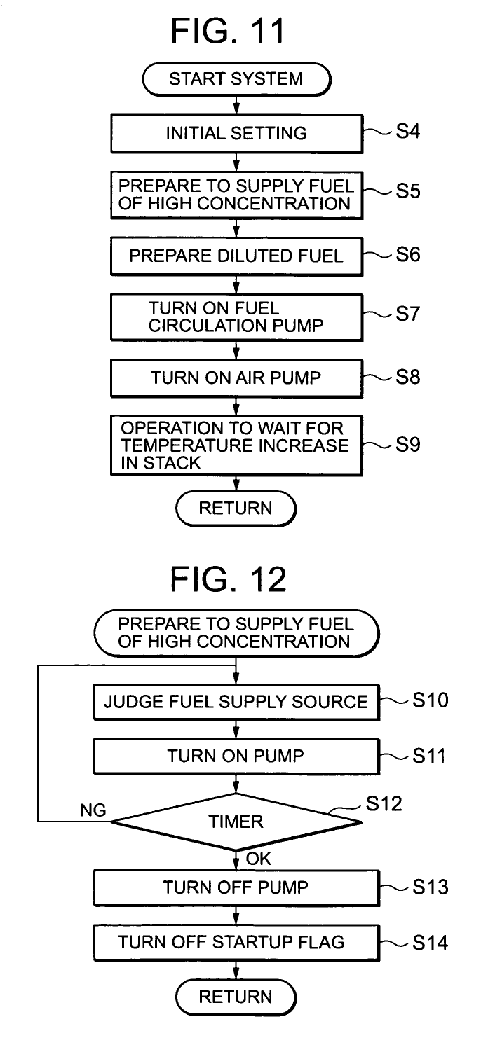

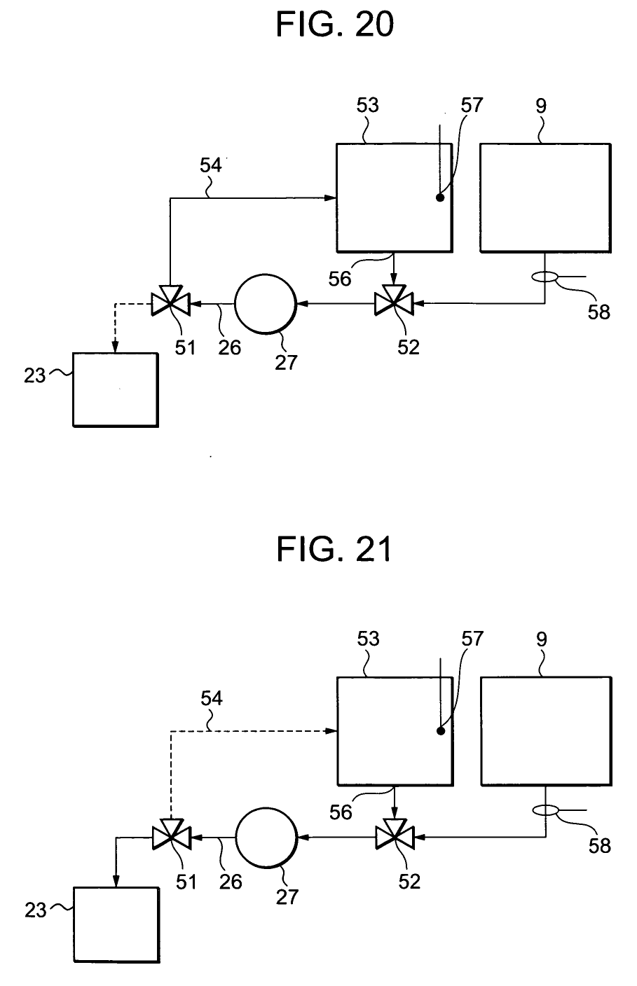

With the configuration described above, an operation of the fuel cell system 1 in this case will next be described referring to flowcharts of FIG. 10 to FIG. 19 and diagrams of FIG. 20 to FIG. 24 explaining the operation. FIG. 10 to FIG. 19 are control flowcharts for the above-mentioned microcomputer on the control substrate 37, of which FIG. 10 is the main flowchart. The microcomputer on the control substrate 37 starts operation and first performs a system startup process at step S1 of FIG. 10. FIG. 11 is a flowchart for this system startup process. The microcomputer performs initial setting at step S4 of FIG. 11, turns off the three-way valves 51 and 52, turns off a cartridge preparation waiting flag, and turns on a startup flag. Next, the microcomputer performs a high concentration fuel supply preparation process at step S5.

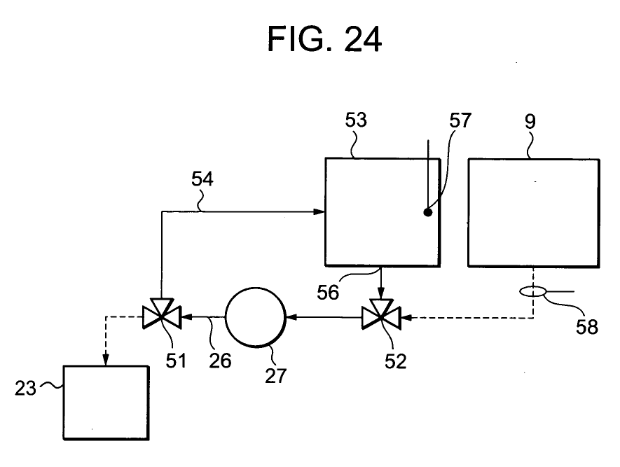

FIG. 12 is a flowchart for this high concentration fuel supply preparation process. The microcomputer performs a process of judging a fuel supply source at step S10 of FIG. 12. FIG. 13 is a flowchart for this process of judging the fuel supply source. At step S15 of FIG. 13, the microcomputer first judges, in accordance with the fuel container switch 59, whether or not the joint 9A of the fuel container 9 (cartridge) is connected to the joint 2B of the case 2. When it is not connected, the microcomputer, at step S21, issues a warning that there is no cartridge (no fuel container) by use of, for example, an unshown warning lamp (state in FIG. 24). Next, at step S23, the microcomputer judges whether or not an amount of methanol in the fuel sub-tank 53 is below a lower limit level (L), and when it is above the lower limit level (L), the microcomputer selects, at step S24, the fuel sub-tank 53 as the supply source of the fuel and turns on the three-way valve 52. When the amount of methanol is below the lower limit level (L), the microcomputer stops the system at step S25.

On the other hand, when the fuel container 9 is set in the fuel container attachment portion 2A of the case 2 and the joint 9A is connected to the joint 2B, the microcomputer proceeds from step S15 to step S16, and judges whether or not it is time to start the system. Since the startup flag is currently turned on, the microcomputer proceeds from step S16 to step S19, and judges, in accordance with the level sensor 57, whether or not the amount of methanol in the fuel sub-tank 53 is above an upper limit level (H).

Now, if the amount of methanol in the fuel sub-tank 53 is lower than the upper limit level (H), the microcomputer proceeds from step S19 to step S20, and selects the fuel container 9 (cartridge) as the fuel supply source and turns off the three-way valve 52. Next, the microcomputer operates (ON) the fuel pump 27 at step S11 of FIG. 12, and repeats step S10 to step S12 until a timer which the microcomputer possesses as its function finishes counting at step S12.

At this time, the three-way valves 51 and 52 are turned off, so that if the fuel pump 27 is operated, methanol of high concentration is drawn from the fuel container 9 (the above-mentioned fuel bag 47), and sucked into the fuel pump 27 by way of the fuel supply pipe 26. It is then discharged from the fuel pump 27 and flows into the fuel sub-tank 53 by way of the air bubble collecting pipe 54. At the same time, air bubbles flown into the fuel supply pipe 26 are collected into the fuel sub-tank 53 (state in FIG. 20).

Such an operation to collect the air bubbles into the fuel sub-tank 53 is performed for a predetermined time (this time signifies a few seconds, that is, time for the fuel sub-tank 53 to go beyond the upper limit level (H) without causing overflow and to ensure that the air bubbles in the fuel supply pipe 26 can be collected), and when the timer has finished counting, the microcomputer proceeds from step S12 to step S13, and stops (OFF) the fuel pump 27 to finish the operation to collect the air bubbles into the fuel sub-tank 53. Then, the startup flag is turned off at step S14.

Next, the three-way valve 51 is turned on at step S6, the fuel pump 27 is operated to supply methanol of high concentration from the fuel container 9 to the buffer tank 23, and methanol is diluted in the buffer tank 23 to prepare a diluted fuel (methanol solution). Then, a fuel circulation pump 31 is operated (ON) at step S7, and an air pump 32 is operated (ON) at step S8. Thus, the methanol solution is supplied to anodes of cells 3A, and air which is an oxidant is supplied to a cathode thereof, thereby starting the electrochemical reaction described above. Further, this electrochemical reaction will increase a temperature of a fuel cell 3. The microcomputer then performs an operation to wait for a temperature increase in a stack (fuel cell 3) at step S9.

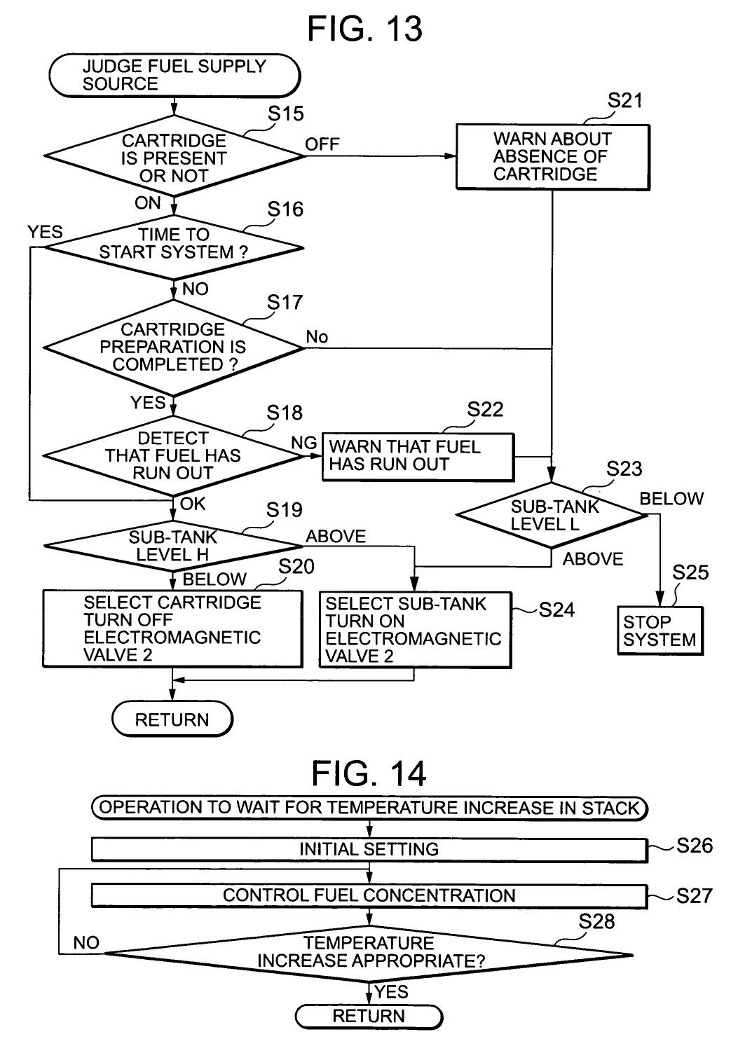

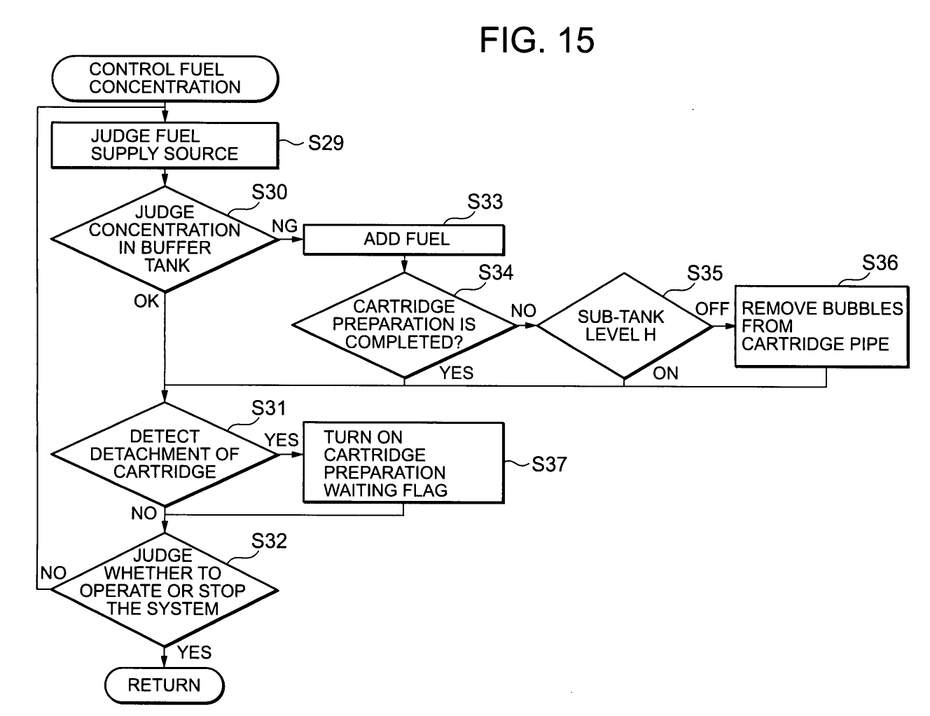

FIG. 14 is a flowchart for this operation to wait for the temperature increase in the stack. The microcomputer performs the initial setting at step S26, and then performs a fuel concentration control process at step S27. This fuel concentration control process is sequentially performed in parallel with the main flowchart, and FIG. 15 is a flowchart for this process. The microcomputer first performs, at step S29, the above-mentioned process of judging the fuel supply source in FIG. 13. As the system startup flag is turned off in this case, the microcomputer proceeds from step S16 to step S17 and judges whether or not preparation of the cartridge is completed. At this time, because the cartridge preparation waiting flag is turned off, the microcomputer proceeds to step S18 and judges whether or not the level sensor 58 has detected that the fuel has run out.

When no methanol is in the fuel supply pipe 26 in the vicinity of the joint 2B, the microcomputer issues, at step S22, a warning that the fuel has run out by use of an unshown lamp, and then proceeds to step S23. When methanol is present in the fuel supply pipe 26 in the vicinity of the joint 2B, which means that the fuel has not run out, the microcomputer proceeds to step S19, and judges whether or not the amount of methanol in the fuel sub-tank 53 is above the upper limit level (H). If it is above the upper limit level (H), the microcomputer proceeds to step S24, and selects the fuel sub-tank 53 as the supply source of the fuel, and then turns on the three-way valve 52. That is, when the amount of methanol in the fuel sub-tank 53 is above the upper limit level (H), the three-way valve 52 is turned on so that methanol is drawn from the fuel sub-tank 53 by the subsequent operation of the fuel pump 27, and when the amount of methanol in the fuel sub-tank 53 is lower than the upper limit level (H), the microcomputer proceeds from step S19 to step S20 and turns off the three-way valve 52, thereby always keeping the amount of methanol in the fuel sub-tank 53 below the upper limit level (H).

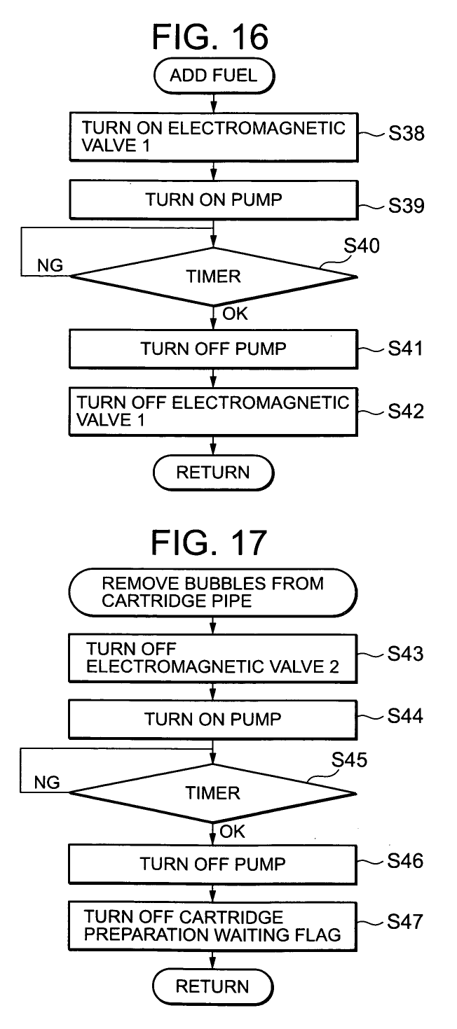

Next, at step S30 of FIG. 15, the microcomputer judges, in accordance with an output of the fuel cell 3, the concentration in the fuel cell 3, and when the microcomputer judges that the output is low and the concentration is low, it performs a fuel addition process at step S33. This fuel addition process is shown in FIG. 16. The microcomputer turns on the three-way valve 51, and operates (ON) the fuel pump 27 at step S39 (state in FIG. 21). At step S40, the microcomputer performs counting using the timer which it possesses as its function, and maintains this state (the three-way valve 51 is on and the fuel pump 27 is on) until the counting finishes. When a predetermined period has passed and the timer has finished counting, the fuel pump 27 is stopped (OFF) at step S41, and the three-way valve 51 is turned off at step S42.

Thus, the fuel cell pump 27 and the three-way valve 51 are intermittently turned on and off so that the concentration of the methanol solution diluted in the buffer tank 23 is maintained at the same concentration as that in the above-mentioned embodiment. Further, the three-way valve 51 is turned off so that backflow of the methanol solution from the buffer tank 23 to the fuel supply pipe 26 is prevented as in the above-mentioned embodiment. Moreover, since the three-way valve 51 is also in the vicinity of the buffer tank 23, diffusion is minimized.

Next, at step S34 of FIG. 15, the microcomputer judges whether or not the fuel container (cartridge) 9 has been prepared. As the cartridge preparation waiting flag is also turned off in this case, the microcomputer proceeds to step S31, and judges, in accordance with the fuel container switch 59, whether or not detachment of the fuel container 9 has been detected. When the detachment has not been detected, the microcomputer judges whether to operate or stop the system at step S32, and sequentially and repeatedly performs this fuel concentration control process unless an operation is performed to stop the system. Subsequently, at step S28 of FIG. 14, the microcomputer judges, in accordance with an output of a temperature sensor 39, whether or not the temperature of the fuel cell 3 has risen to a temperature required for its operation, and if it has not risen thereto, the microcomputer repeats step S27, and if it has risen thereto, the microcomputer moves to a steady operation at step S2.

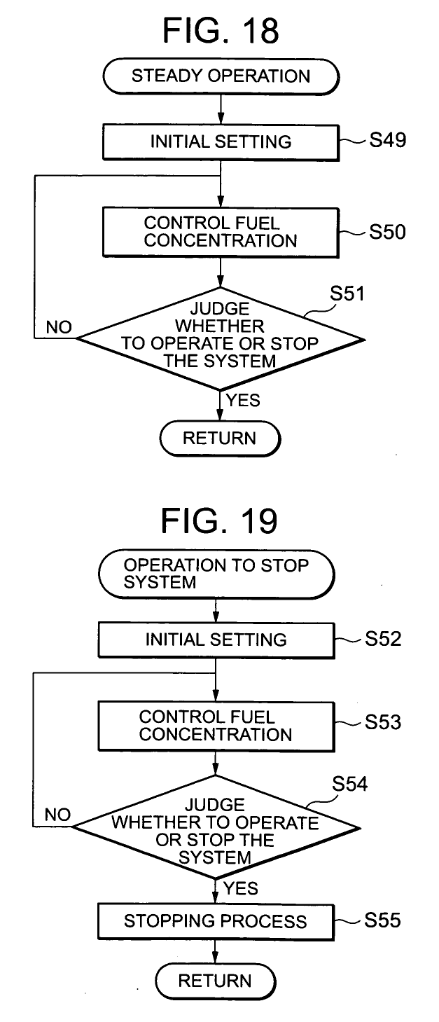

FIG. 18 is a flowchart for this steady operation. In this steady operation, the microcomputer performs the initial setting at step S49, and then performs the fuel concentration control process of FIG. 15 at step S50. The microcomputer then judges whether to operate or stop the system at step S51, and moves back to step S50 to repeat the process unless the operation is performed to stop the system.

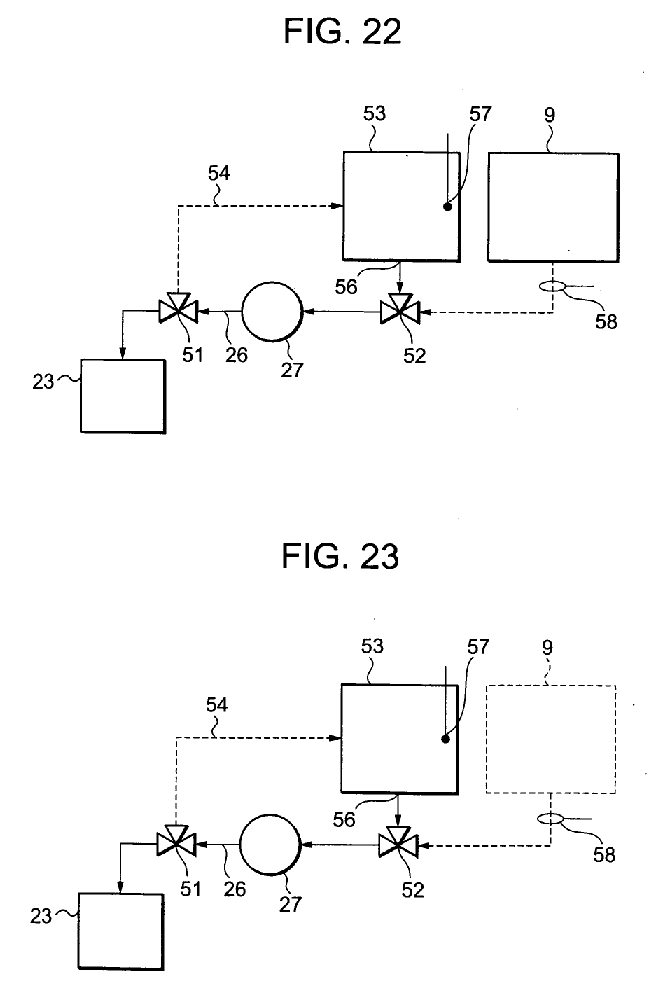

Here, when methanol of high concentration in the fuel container 9 has run out and it is detected at step S18 of FIG. 13 that the fuel has run out, the microcomputer issues, at step S22, the warning that the fuel has run out by use of the lamp, and then proceeds to step S23. At this point, if methanol in the fuel sub-tank 53 is above the lower limit level (L) thereof, the microcomputer selects the fuel sub-tank 53 as the fuel supply source at step S24, and then turns on the three-way valve 52 (state in FIG. 22).

If a user removes the fuel container 9 from the fuel container attachment portion 2A of the case 2 to replace the fuel container 9 in response to the fact that the warning has been issued at step S22 that the fuel has run out, the microcomputer detects this from the fuel container switch 59, so that the microcomputer proceeds from step S31 to step S37 of FIG. 15 and turns on the cartridge preparation waiting flag. Further, in FIG. 13, the microcomputer proceeds to step S23 from step S15 by way of step S21, so that if methanol in the fuel sub-tank 53 is above the lower limit level (L) thereof, the microcomputer selects at step S24 the fuel sub-tank 53 as the fuel supply source, and then turns on the three-way valve 52 (state in FIG. 23).

Thus, as long as methanol above the lower limit level (L) is collected in the fuel sub-tank 53, methanol of high concentration is supplied from the fuel sub-tank 53 to the buffer tank 23 in the subsequent fuel addition process even if the fuel in the fuel container 9 has run out of the fuel and even if the fuel container 9 is detached, and therefore, the operation of the fuel cell system 1 can be continuously executed even when the fuel has run out. It is to be noted that when methanol in the fuel sub-tank 53 has been reduced to the lower limit level (L), the microcomputer proceeds from step S23 to step S25 and stops the system.

Furthermore, the cartridge preparation waiting flag is still on even if the user attaches the new fuel container 9 to the fuel container attachment portion 2A and connects the joint 9A to the joint 2B, and the microcomputer thus proceeds to step S23 from step S17 of FIG. 13. On the other hand, the microcomputer proceeds from step S34 to step S35 in FIG. 15 and judges whether or not the amount of methanol in the fuel sub-tank 53 is above the upper limit level (H), and if it is lower than the upper limit level (H), the microcomputer proceeds to step S36 and performs a cartridge pipe bubble removing process.

FIG. 17 is a flowchart for this cartridge pipe bubble removing process. The microcomputer turns off the three-way valve 52 at step S43, operates (ON) the fuel pump 27 at step S44, and at step S45, continues the off state of the three-way valve 52 and the operation (ON) of the fuel pump 27 until the timer (the same timer as that in FIG. 12) which the microcomputer possesses as its function finishes counting.

The three-way valve 51 is off at this point when the process at step S33 has been finished, so that if the fuel pump 27 is operated, methanol of high concentration is drawn from the fuel container 9 (the above-mentioned fuel bag 57), and sucked into the fuel pump 27 by way of the fuel supply pipe 26. It is then discharged from the fuel pump 27 and flows into the fuel sub-tank 53 by way of the air bubble collecting pipe 54. Thus, the air bubbles mixed into the fuel supply pipe 26 due to the detachment of the fuel container 9 are collected into the fuel sub-tank 53 at the same time (state in FIG. 20).

Such an operation to collect the air bubbles into the fuel sub-tank 53 is performed for a predetermined time as described above, and when the above-mentioned timer has finished counting, the microcomputer proceeds from step S45 to step S46, and stops (OFF) the fuel pump 27 to finish the operation to collect the air bubbles into the fuel sub-tank 53. Then, the cartridge preparation waiting flag is turned off at step S47. Because the cartridge preparation waiting flag is turned off, the microcomputer then proceeds from step S17 to step S18 and will therefore return to the operation described above.

Furthermore, if an operation to stop the system is performed by the user, the microcomputer proceeds from step S51 to step S3 to execute a system stopping operation. FIG. 19 is a flowchart for this system stopping operation. The microcomputer performs the initial setting at step S52, and performs the fuel concentration control process of FIG. 15 at step S53. The microcomputer then judges whether to operate or stop the system at step S51, and executes the stopping operation at step S55 because the operation has been performed to stop the system.

As described above, in accordance with the configuration in this case, the air bubbles in the fuel supply pipe 26 can be collected into the fuel sub-tank 53. In this way, the air bubbles mixed into the fuel supply pipe 26, for example, when the fuel container 9 is replaced are smoothly collected, and such a disadvantage is prevented that electricity cannot be generated due to air flowing into the anodes of the cells 3A, thereby achieving stable electricity generation capacity.

In particular, as in the embodiment, the fuel pump 27, the fuel sub-tank 53 and the three-way valves 51, 52 are used for the fuel supply pipe 26, and the three-way valves 51, 52 are turned off to bring the entrance of the fuel sub-tank 53 into communication with the fuel supply pipe 26 in order to operate the fuel pump 27, so that the air bubbles in the fuel supply pipe 26 are collected into the fuel sub-tank 53, whereby the air bubbles mixed in fuel supply pipe 26 can be absolutely and rapidly collected into the fuel sub-tank 53 together with methanol of high concentration.

Furthermore, the three-way valves 51, 52 are turned on and an exit of the fuel sub-tank 53 is brought into communication with the fuel supply pipe 26 to operate the fuel pump 27, so that methanol of high concentration in the fuel sub-tank 53 is supplied to the buffer tank 23. Consequently, even while the fuel container 9 is removed for replacement, methanol of high concentration collected into the fuel sub-tank 53 can be supplied to the buffer tank 23 to continue the electricity generation by the fuel cell 3.

It is to be noted that the embodiments have been described on the assumption that the liquid fuel contained in the fuel container 9 is substantially 100% pure methanol, but this is not a limitation, and the present invention is also beneficial when methanol solution of high concentration of about 20 mol/L is contained in the fuel container 9 for safety reasons. Further, the present invention has been applied to the fuel cell system including the DMFC which uses methanol as the liquid fuel in the embodiments described above, but it is not limited thereto, and the present invention is beneficial to all the fuel cell systems which dilute the liquid fuel and use it for electricity generation.

What is claimed is:

1. A fuel cell system which generates electricity by an electrochemical reaction between a liquid fuel and an oxidant, the system comprising:
a cell which generates electricity by the electrochemical reaction;
a fuel container containing the liquid fuel of high concentration; and
a buffer tank which dilutes the liquid fuel in the fuel container to supply the diluted liquid fuel to an anode of the cell,
wherein backflow prevention means is provided in a fuel supply path between the fuel container and the buffer tank to prevent the liquid fuel from flowing back from the buffer tank to the fuel container.

2. The fuel cell system according to claim 1, wherein the backflow prevention means is provided in the vicinity of the buffer tank in the fuel supply path.

3. The fuel cell system according to claim 1 or 2, comprising a pump to supply the buffer tank with the liquid fuel in the fuel container,
wherein the backflow prevention means comprises a valve device which opens/closes synchronously with an operation/stopping of the pump.

4. The fuel cell system according to claim 1 or 2,
wherein the backflow prevention means comprises a check valve which allows the liquid fuel to pass from the fuel container to the buffer tank and which deters the liquid fuel from passing from the buffer tank to the fuel container.

5. A fuel cell system which generates electricity by an electrochemical reaction between a liquid fuel and an oxidant, the system comprising:
a cell which generates electricity by the electrochemical reaction;
a buffer tank which dilutes the liquid fuel of high concentration to supply the diluted liquid fuel to an anode of the cell;
a fuel supply path which supplies the liquid fuel of high concentration to the buffer tank;
a fuel container containing the liquid fuel of high concentration and detachably connected to the fuel supply path; and
an air bubble collecting means for collecting air bubbles in the fuel supply path.

6. The fuel cell system according to claim 5, wherein the air bubble collecting means comprises a pump provided in the fuel supply path to supply the buffer tank with the liquid fuel in the fuel container, a fuel sub-tank and flow path switching means; and
an entrance of the fuel sub-tank is brought into communication with the fuel supply path by the flow path switching means and the pump is operated in order to collect, into the fuel sub-tank, the air bubbles in the fuel supply path, while an exit of the fuel sub-tank is brought into communication with the fuel supply path by the flow path switching means and the pump is operated in order to supply the buffer tank with the liquid fuel in the fuel sub-tank.

7. The fuel cell system according to claim 6, wherein the pump is operated while the fuel container is brought into communication, via the fuel supply path, with the buffer tank by the flow path switching means in order to supply the liquid fuel from the fuel container to the buffer tank; and
when the pump is stopped, the flow path switching means deters the liquid fuel from flowing from the buffer tank to the fuel supply path.

8. A fuel cell system which generates electricity by an electrochemical reaction between a liquid fuel and an oxidant, the system comprising:
a cell which generates electricity by the electrochemical reaction;
a buffer tank which dilutes the liquid fuel of high concentration to supply the diluted liquid fuel to an anode of the cell;
a fuel supply path which supplies the liquid fuel of high concentration to the buffer tank; and
a fuel container containing the liquid fuel of high concentration and detachably connected to the fuel supply path,
wherein the fuel container comprises an exterior case, and a fuel bag housed in the exterior case and filled with the liquid fuel; and
the fuel bag has a plurality of compartments in communication with each other and is housed in the exterior case in a folded state.
